(19) United States
(12) Patent Application Publication
(10) Pub. No.: US 2013/0061292 A1
(43) Pub. Date: Mar. 7, 2013

(54) METHODS AND SYSTEMS FOR PROVIDING NETWORK SECURITY IN A PARALLEL PROCESSING ENVIRONMENT

(71) Applicant: Andrew C. FELCH, Palo Alto, CA (US)

(72) Inventor: Andrew C. FELCH, Palo Alto, CA (US)

(73) Assignee: COGNITIVE ELECTRONICS, INC., Lebanon, NH (US)

(21) Appl. No.: 13/594,207

(22) Filed: Aug. 24, 2012

Related U.S. Application Data
(60) Provisional application No. 61/528,075, filed on Aug. 26, 2011.

(51) Int. Cl. G06F 21/20

(52) U.S. Cl. 726/4; 726/3

(57) ABSTRACT

A method of providing network security for executing applications is disclosed. One or more servers including a plurality of microprocessors and a plurality of network processors are provided. A first grouping of microprocessors executes a first application. The first application is executed using the microprocessors in the first grouping. The microprocessors in the first grouping of microprocessors are permitted to communicate with each other via one or more of the network processors. A second grouping of microprocessors executes a second application. At least one server has one or more microprocessors for executing the first application and one or more different microprocessors for executing the second application. The second application is executed using the microprocessors in the second grouping of microprocessors. One or more of the network processors prevent the microprocessors in the first grouping from communicating with the microprocessors in the second grouping during periods of simultaneous execution.

### CROSS-REFERENCE TO RELATED APPLICATIONS

This application claims priority to U.S. Provisional Patent Application No. 61/528,075 filed Aug. 26, 2011, which is incorporated herein by reference.

### BACKGROUND OF THE INVENTION

Security is an important part of cloud computing and high performance computing (HPC). While many applications that originated in clusters and private datacenters continue to move to private and public clouds, this progress is not anticipated to be sustainable unless users feel that the security infrastructure of the new systems is trustworthy. Various types of attacks require different types of security precautions,

Accordingly, it is desirable to provide computer architecture making unauthorized penetration more difficult and easier to prevent.

### BRIEF DESCRIPTION OF THE INVENTION

In one embodiment, a method of providing network security for executing a plurality of applications is disclosed. The network includes one or more servers. Each server includes a plurality of microprocessors and a plurality of network processors. A first grouping of microprocessors is defined for executing a first application. The first application is executed using the microprocessors in the first grouping of microprocessors. The microprocessors in the first grouping of microprocessors are permitted to communicate with each other via one or more of the network processors. A second grouping of microprocessors is defined for executing a second application. At least one server has one or more microprocessors for executing the first application and one or more different microprocessors for executing a second application. The second application is executed using the microprocessors in the second grouping of microprocessors. Execution of the second application is initiated prior to the completion of execution of the first application. The microprocessors in the second grouping of microprocessors are permitted to communicate with each other via one or more of the network processors. One or more of the network processors prevent the microprocessors in the first grouping of microprocessors from communicating with the microprocessors in the second grouping of microprocessors during periods of simultaneous execution of the first and second application.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an overview of a parallel computing architecture;

FIG. 2 is an illustration of a program counter selector for use with the parallel computing architecture of FIG. 1;

FIG. 3 is a block diagram showing an example state of the architecture;

FIG. 4 is a block diagram illustrating cycles of operation during which eight Virtual Processors execute the same program but starting at different points of execution;

FIG. 5 is a block diagram of a multi-core system-on-chip;

FIG. 6A is a schematic block diagram of a plurality of servers grouped into execution groups in a data center network in accordance with one preferred embodiment of this invention;

FIG. 6B is a schematic block diagram of a server in the data center network having a plurality of microprocessors grouped into execution groups in accordance with one preferred embodiment of this invention;

FIG. 7A is a schematic block diagram illustrating initiation of a selected program through a program initiation server in accordance with one preferred embodiment of this invention;

FIG. 7B is a flow chart illustrating steps for the Key Distribution and Network Initialization Server transforming Network Initialization Commands into multiple messages output to the Security and Initialization Network server in accordance with one preferred embodiment of this invention;

FIG. 8 is a schematic block diagram of a Security and Initialization Network in accordance with one preferred embodiment of this invention;

FIG. 9 is a schematic block diagram illustrating the communication channels by which the security network node informs the network processors and microprocessors of security and boot data in accordance with one preferred embodiment of this invention;

FIG. 10 is a schematic block diagram of a network processor in accordance with one preferred embodiment of this invention;

FIG. 11 is a schematic block diagram illustrating encryption and decryption mechanisms built into the processors in accordance with one preferred embodiment of this invention;

FIG. 12 is a flow chart illustrating steps of a first application that may be run simultaneously with another application in accordance with one preferred embodiment of this invention;

FIG. 13 is a flow chart illustrating steps of a second program that may be run simultaneously with another application in accordance with one preferred embodiment of this invention;

FIG. 14 is a schematic block diagram showing a configuration of network processors with the programs of FIGS. 12 and 13 simultaneously executing in accordance with one preferred embodiment of this invention; and

FIG. 15 is a flow chart illustrating steps by which network security is provided to the applications of FIGS. 12 and 13 during periods of simultaneous execution in accordance with one preferred embodiment of this invention.

### DETAILED DESCRIPTION OF THE INVENTION

### Definitions

The following definitions are to be applied to terminology used in the application:

Network processor—A processor that connects to multiple nodes and passes messages between those nodes. The network processor is preferably able to perform some operations on the communicated packets, such as performing a check before a packet is forwarded to its proper destination port. Such a check is performed in order to verify that packets sent from the sender of a packet are allowed, according to the rules initialized into the network, to be passed to the destination.

Simultaneous execution—Capability for a first program to be operating in the system at the same time as a second program is also operating in the system. For example, a first program may be checking web pages for certain keywords using Processors A and B, while a second program is deleting redundant web pages on Processors C and D. When processors A, B, C, and D reside on the same physical network, the network processors and/or network switches perform some operations for the first program, and some operations for the second program, often performing operations for the first program using one part of a network processor while other parts of the same network processor are performing operations for the second program.

For example, processor A might be passing a message to processor B while processor C passes a message to processor D. The network processor may receive the messages from A and C before those either of those messages have been forwarded on, thereby operating in a situation where the programs are simultaneously executing.

### DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, methods and systems for providing security to applications executing in a parallel computing architecture are disclosed. The following description of a parallel computing architecture is one example of an architecture that may be used with the network security features of the preferred embodiment. The architecture is further described in commonly assigned U.S. Patent Application Publication No. 2009/0083263 (Felch et al.), which is incorporated by reference herein.

Parallel Computing Architecture

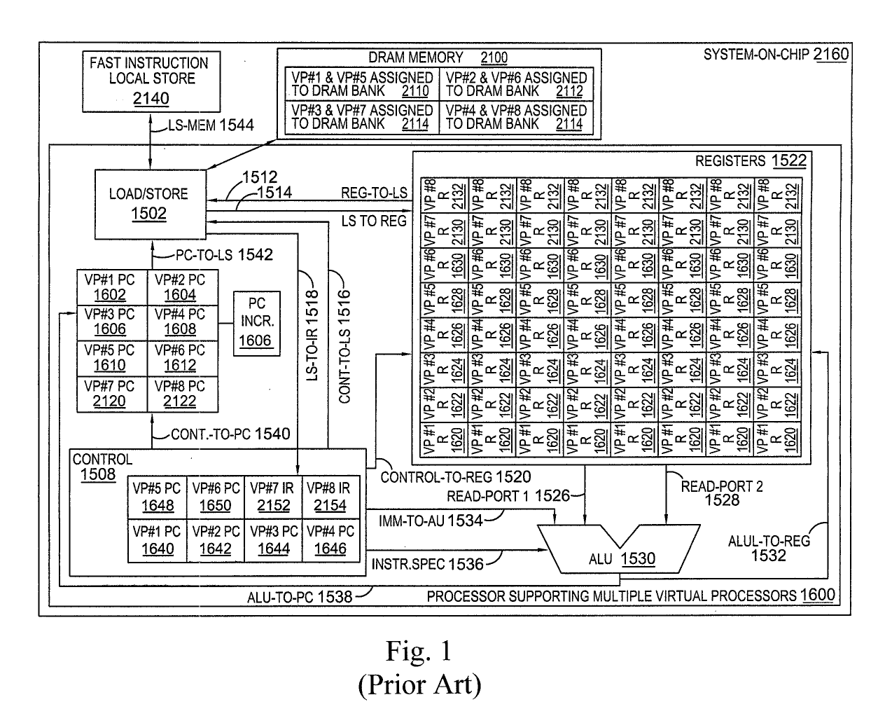

FIG. 1 is a block diagram schematic of a processor architecture 2160 utilizing on-chip DRAM(2100) memory storage as the primary data storage mechanism and Fast Instruction Local Store, or just Instruction Store, 2140 as the primary memory from which instructions are fetched. The Instruction Store 2140 is fast and is preferably implemented using SRAM memory. In order for the Instruction Store 2140 to not consume too much power relative to the microprocessor and DRAM memory, the Instruction Store 2140 can be made very small. Instructions that do not fit in the SRAM are stored in and fetched from the DRAM memory 2100. Since instruction fetches from DRAM memory are significantly slower than from SRAM memory, it is preferable to store performance-critical code of a program in SRAM. Performance-critical code is usually a small set of instructions that are repeated many times during execution of the program.

The DRAM memory 2100 is organized into four banks 2110, 2112, 2114 and 2116, and requires 4 processor cycles to complete, called a 4-cycle latency. In order to allow such instructions to execute during a single Execute stage of the Instruction, eight virtual processors are provided, including new VP#7 (2120) and VP#8 (2122). Thus, the DRAM memories 2100 are able to perform two memory operations for every Virtual Processor cycle by assigning the tasks of two processors (for example VP#1 and VP#5 to bank 2110). By elongating the Execute stage to 4 cycles, and maintaining single-cycle stages for the other 4 stages comprising: Instruction Fetch, Decode and Dispatch, Write Results, and Increment PC; it is possible for each virtual processor to complete an entire instruction cycle during each virtual processor cycle. For example, at hardware processor cycle T=1 Virtual Processor #1 (VP#1) might be at the Fetch instruction cycle. Thus, at T=2 Virtual Processor #1 (VP#1) will perform a Decode & Dispatch stage. At T=3 the Virtual Processor will begin the Execute stage of the instruction cycle, which will take 4 hardware cycles (half a Virtual Processor cycle since there are 8 Virtual Processors) regardless of whether the instruction is a memory operation or an ALU 1530 function. If the instruction is an ALU instruction, the Virtual Processor might spend cycles 4, 5, and 6 simply waiting. It is noteworthy that although the Virtual Processor is waiting, the ALU is still servicing a different Virtual Processor (processing any non-memory instructions) every hardware cycle and is preferably not idling. The same is true for the rest of the processor except the additional registers consumed by the waiting Virtual Processor, which are in fact idling. Although this architecture may seem slow at first glance, the hardware is being fully utilized at the expense of additional hardware registers required by the Virtual Processors. By minimizing the number of registers required for each Virtual Processor, the overhead of these registers can be reduced. Although a reduction in usable registers could drastically reduce the performance of an architecture, the high bandwidth availability of the DRAM memory reduces the penalty paid to move data between the small number of registers and the DRAM memory.

This architecture 1600 implements separate instruction cycles for each virtual processor in a staggered fashion such that at any given moment exactly one VP is performing Instruction Fetch, one VP is Decoding Instruction, one VP is Dispatching Register Operands, one VP is Executing Instruction, and one VP is Writing Results. Each VP is performing a step in the Instruction Cycle that no other VP is doing. The entire processor's 1600 resources are utilized every cycle. Compared to the naïve processor 1500 this new processor could execute instructions six times faster.

As an example processor cycle, suppose that VP#6 is currently fetching an instruction using VP#6 PC 1612 to designate which instruction to fetch, which will be stored in VP#6 Instruction Register 1650. This means that VP#5 is Incrementing VP#5 PC 1610, VP#4 is Decoding an instruction in VP#4 Instruction Register 1646 that was fetched two cycles earlier. VP #3 is Dispatching Register Operands. These register operands are only selected from VP#3 Registers 1624. VP#2 is Executing the instruction using VP#2 Register 1622 operands that were dispatched during the previous cycle. VP#1 is Writing Results to either VP#1 PC 1602 or a VP#1 Register 1620.

During the next processor cycle, each Virtual Processor will move on to the next stage in the instruction cycle. Since VP#1 just finished completing an instruction cycle it will start a new instruction cycle, beginning with the first stage, Fetch Instruction.

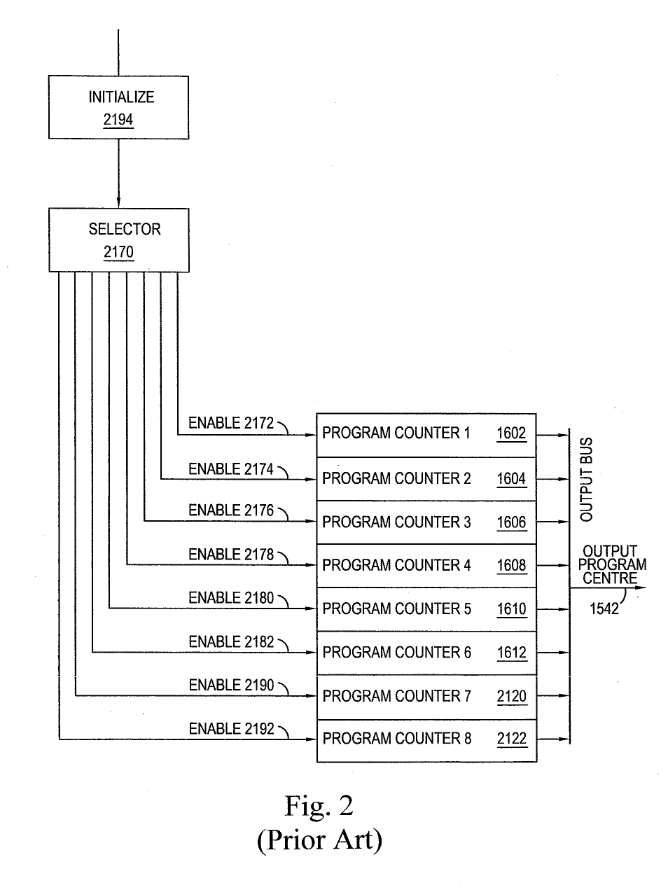

Note, in the architecture 2160, in conjunction with the additional virtual processors VP#7 and VP#8, the system control 1508 now includes VP#7 IR 2152 and VP#8 IR 2154. In addition, the registers for VP#7 (2132) and VP#8 (2134) have been added to the register block 1522. Moreover, with reference to FIG. 2, a Selector function 2110 is provided within the control 1508 to control the selection operation of each virtual processor VP#1-VP#8, thereby maintaining the orderly execution of tasks/threads, and optimizing advantages of the virtual processor architecture the has one output for each program counter and enables one of these every cycle. The enabled program counter will send its program counter value to the output bus, based upon the direction of the selector 2170 via each enable line 2172, 2174, 2176, 2178, 2180, 2182, 2190, 2192. This value will be received by Instruction Fetch unit 2140. In this configuration the Instruction Fetch unit 2140 need only support one input pathway, and each cycle the selector ensures that the respective program counter received by the Instruction Fetch unit 2140 is the correct one scheduled for that cycle. When the Selector 2170 receives an initialize input 2194, it resets to the beginning of its schedule. An example schedule would output Program Counter 1 during cycle 1, Program Counter 2 during cycle 2, etc. and Program Counter 8 during cycle 8, and starting the schedule over during cycle 9 to output Program Counter 1 during cycle 9, and so on . . . . A version of the selector function is applicable to any of the embodiments described herein in which a plurality of virtual processors are provided.

To complete the example, during hardware-cycle T=7 Virtual Processor #1 performs the Write Results stage, at T=8 Virtual Processor #1 (VP#1) performs the Increment PC stage, and will begin a new instruction cycle at T=9. In another example, the Virtual Processor may perform a memory operation during the Execute stage, which will require 4 cycles, from T=3 to T=6 in the previous example. This enables the architecture to use DRAM 2100 as a low-power, high-capacity data storage in place of a SRAM data cache by accommodating the higher latency of DRAM, thus improving power-efficiency. A feature of this architecture is that Virtual Processes pay no performance penalty for randomly accessing memory held within its assigned bank. This is quite a contrast to some high-speed architectures that use high-speed SRAM data cache, which is still typically not fast enough to retrieve data in a single cycle.

Each DRAM memory bank can be architected so as to use a comparable (or less) amount of power relative to the power consumption of the processor(s) it is locally serving. One method is to sufficiently share DRAM logic resources, such as those that select rows and read bit lines. During much of DRAM operations the logic is idling and merely asserting a previously calculated value. Using simple latches in these circuits would allow these assertions to continue and free-up the idling DRAM logic resources to serve other banks Thus the DRAM logic resources could operate in a pipelined fashion to achieve better area efficiency and power efficiency.

Another method for reducing the power consumption of DRAM memory is to reduce the number of bits that are sensed during a memory operation. This can be done by decreasing the number of columns in a memory bank. This allows memory capacity to be traded for reduced power consumption, thus allowing the memory banks and processors to be balanced and use comparable power to each other.

The DRAM memory 2100 can be optimized for power efficiency by performing memory operations using chunks, also called “words”, that are as small as possible while still being sufficient for performance-critical sections of code. One such method might retrieve data in 32-bit chunks if registers on the CPU use 32-bits. Another method might optimize the memory chunks for use with instruction Fetch. For example, such a method might use 80-bit chunks in the case that instructions must often be fetched from data memory and the instructions are typically 80 bits or are a maximum of 80 bits.

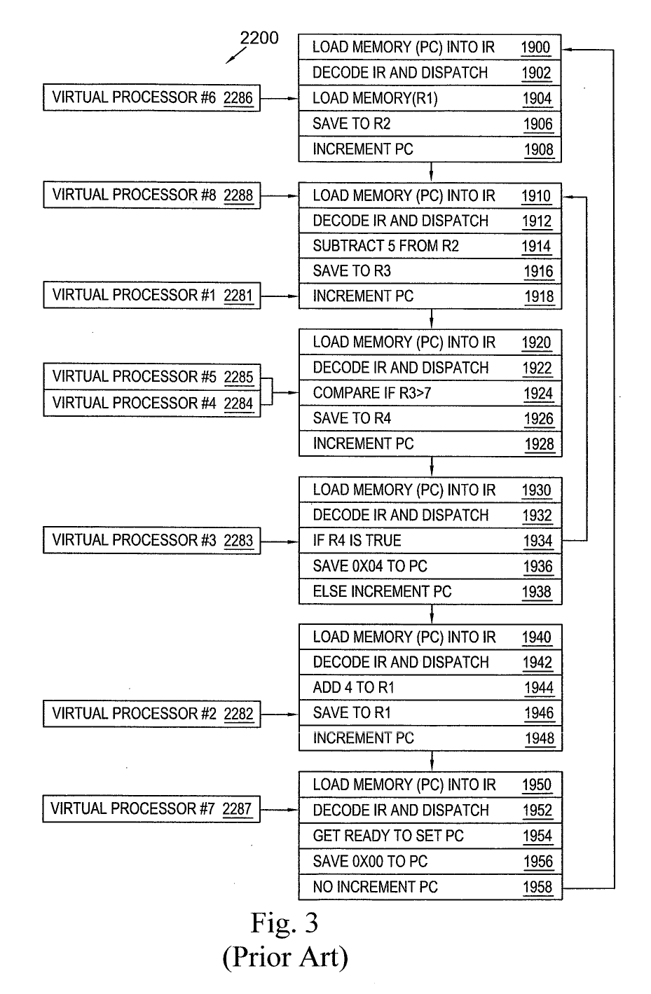

FIG. 3 is a block diagram 2200 showing an example state of the architecture 2160 in FIG. 1. Because DRAM memory access requires four cycles to complete, the Execute stage (1904, 1914, 1924, 1934, 1944, 1954) is allotted four cycles to complete, regardless of the instruction being executed. For this reason there will always be four virtual processors waiting in the Execute stage. In this example these four virtual processors are VP#3 (2283) executing a branch instruction 1934, VP#4 (2284) executing a comparison instruction 1924, VP#5 2285 executing a comparison instruction 1924, and VP#6 (2286) a memory instruction. The Fetch stage (1900, 1910, 1920, 1940, 1950) requires only one stage cycle to complete due to the use of a high-speed instruction store 2140. In the example, VP#8 (2288) is in the VP in the Fetch Instruction stage 1910. The Decode and Dispatch stage (1902, 1912, 1922, 1932, 1942, 1952) also requires just one cycle to complete, and in this example VP#7 (2287) is executing this stage 1952. The Write Result stage (1906, 1916, 1926, 1936, 1946, 1956) also requires only one cycle to complete, and in this example VP#2 (2282) is executing this stage 1946. The Increment PC stage (1908, 1918, 1928, 1938, 1948, 1958) also requires only one stage to complete, and in this example VP#1 (1981) is executing this stage 1918. This snapshot of a microprocessor executing 8 Virtual Processors (2281-2288) will be used as a starting point for a sequential analysis in the next figure.

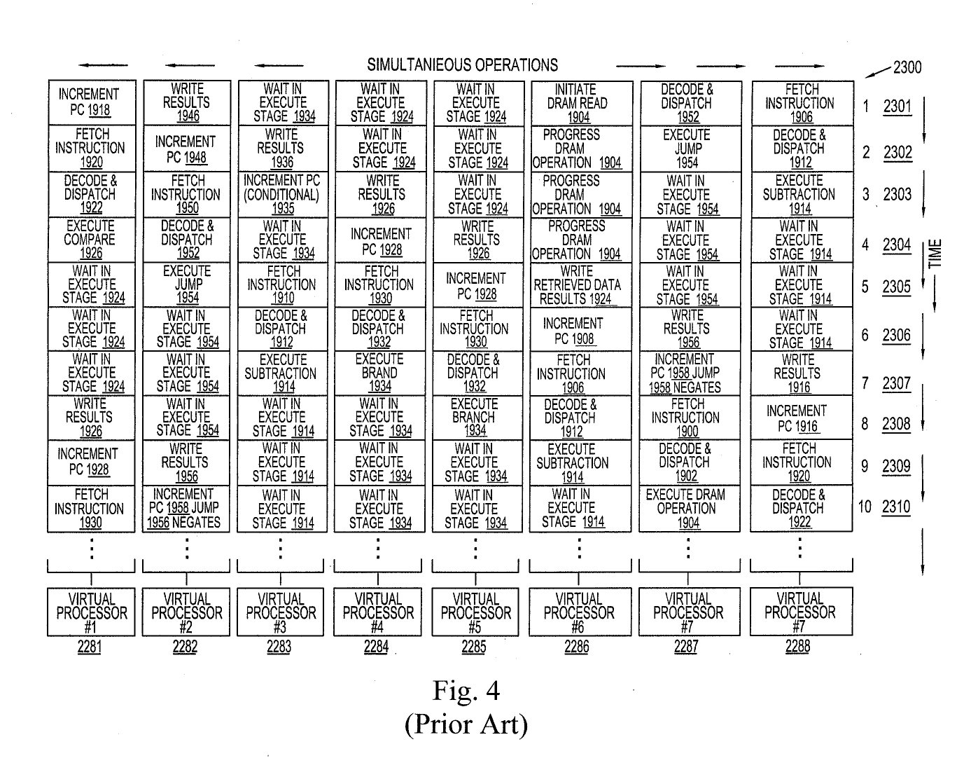

FIG. 4 is a block diagram 2300 illustrating 10 cycles of operation during which 8 Virtual Processors (2281-2288) execute the same program but starting at different points of execution. At any point in time (2301-2310) it can be seen that all Instruction Cycle stages are being performed by different Virtual Processors (2281-2288) at the same time. In addition, three of the Virtual Processors (2281-2288) are waiting in the execution stage, and, if the executing instruction is a memory operation, this process is waiting for the memory operation to complete. More specifically in the case of a memory READ instruction this process is waiting for the memory data to arrive from the DRAM memory banks This is the case for VP#8 (2288) at times T=4, T=5, and T=6 (2304, 2305, 2306).

When virtual processors are able to perform their memory operations using only local DRAM memory, the example architecture is able to operate in a real-time fashion because all of these instructions execute for a fixed duration.

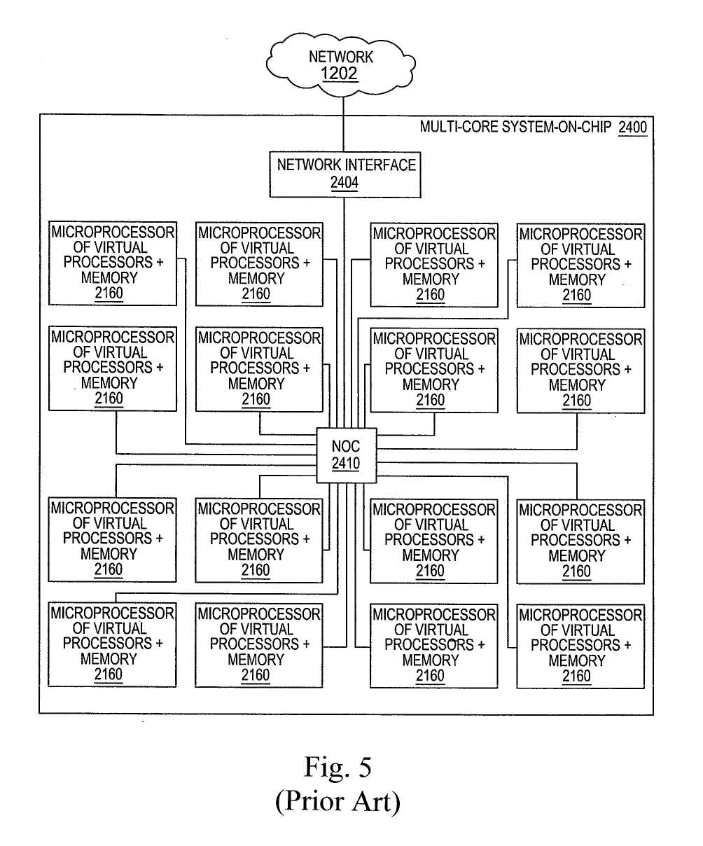

FIG. 5 is a block diagram of a multi-core system-on-chip 2400. Each core is a microprocessor implementing multiple virtual processors and multiple banks of DRAM memory 2160. The microprocessors interface with a network-on-chip (NOC) 2410 switch such as a crossbar switch. The architecture sacrifices total available bandwidth, if necessary, to reduce the power consumption of the network-on-chip such that it does not impact overall chip power consumption beyond a tolerable threshold. The network interface 2404 communicates with the microprocessors using the same protocol the microprocessors use to communicate with each other over the NOC 2410. If an IP core (licensable chip component) implements a desired network interface, an adapter circuit may be used to translate microprocessor communication to the on-chip interface of the network interface IP core.

Network Security

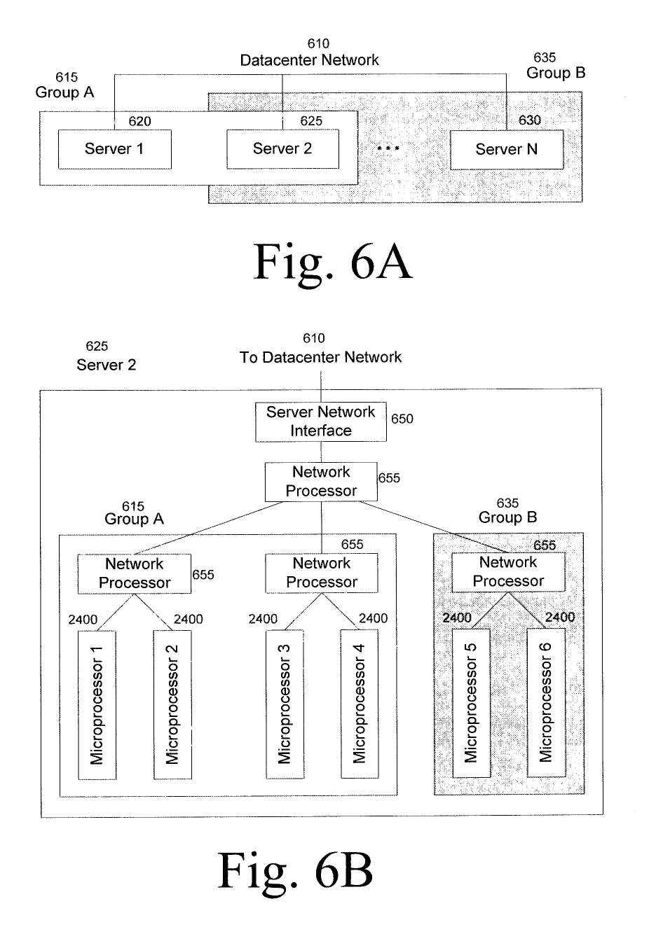

FIGS. 6A and 6B show a block diagram of a computer architecture with network security for communications between microprocessors 2400 executing applications. Groups of microprocessors 615, 635 are defined for executing each application. The network processors 655 are configured to only allow communication between microprocessors 2400 executing the same application. Communication between microprocessors 2400 in different application groups is blocked by the network processors 655.

Referring to FIG. 6A, servers in a datacenter 620, 625, . . . 630 may be dedicated to one or more groups of applications. For example, server 1 620 and part of server 2 625 (e.g., a first plurality of processing cores or Virtual Processors within server 2) are assigned to application group A 615 and the remaining part of server 2 625 through server N 635 are assigned to application group B 635. Referring to FIG. 6B, an expanded version of server 2 is shown. In server 2 625, the four microprocessors 2400 on the left are assigned to group A 615, while the two microprocessors on the right are assigned to group B 635. However, any other division of assignments is possible and is within the scope of this invention.

The network processors 655 may be configured through a separate security network that is not accessible by user applications run on the microprocessors. Microprocessors 2400 in the same group also share an encryption key which is used to encrypt all outgoing data and decrypt incoming data. The encryption keys may be transmitted to the microprocessors 2400 using the security network. The security keys are preferably not directly accessible by the user applications running on the microprocessors so that if malicious code is running on one of these microprocessors it is not able to access the encryption key(s) and it is not able to reconfigure the network processors 655.

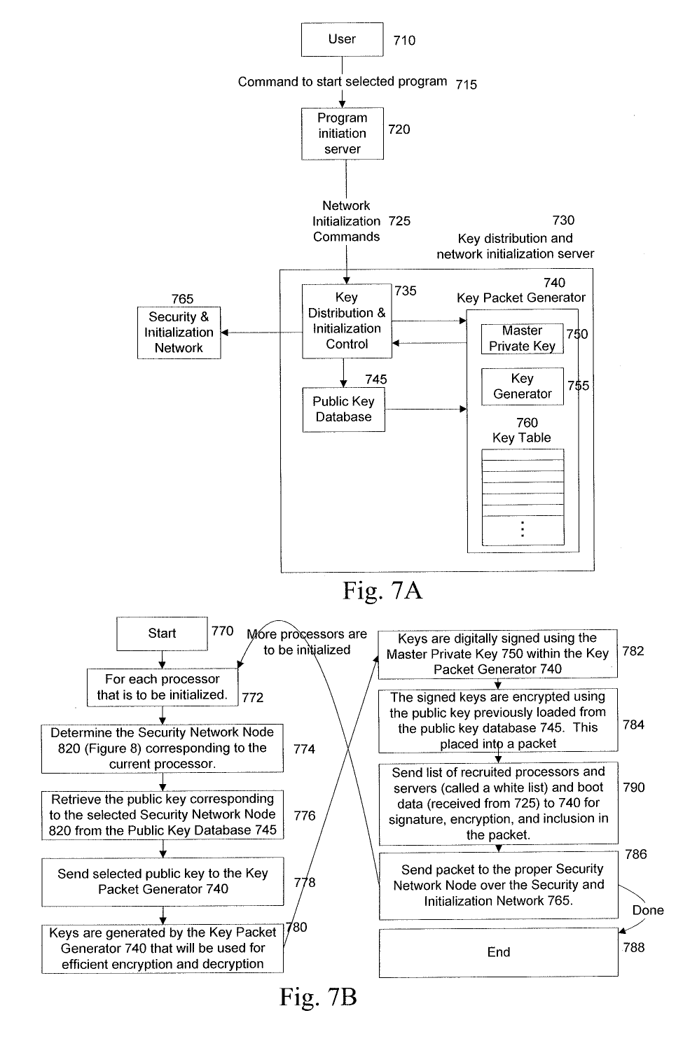

FIG. 7A is a schematic block diagram illustrating initiation of a selected program through a program initiation server 720 in accordance with a preferred embodiment of this invention. The Program initiation server 720 determines what set of processors will be used to run the selected program and what boot commands will need to be sent to the processors in order to boot the selected program. This data, called Network Initialization Commands 725, is sent to the Key distribution and network initialization server 730, and more specifically, to the Key Distribution and Initialization Control 735 (KDIC) within the Key distribution and network initialization server 730. The KDIC 735 creates a message (single or multi-part) to each processor 2400. The message that will be sent is itself encrypted, and will be sent over the network that is dedicated to security and initialization 765.

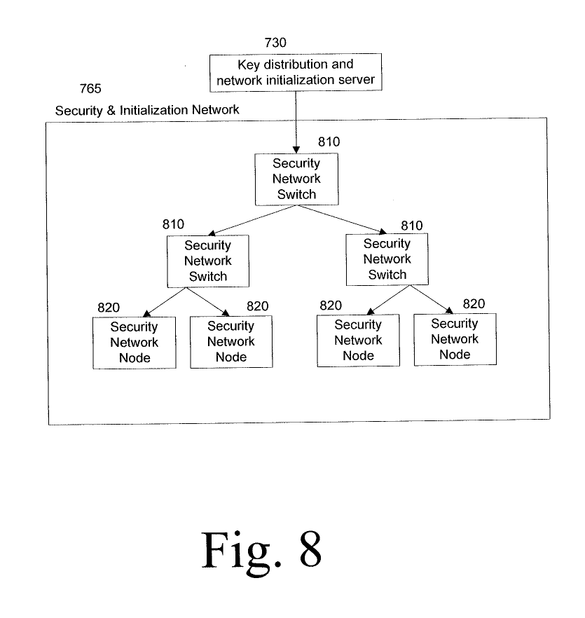

FIG. 7B is a flow chart illustrating how the Key Distribution and Network Initialization Server 730 transforms Network Initialization Commands 725 into multiple messages output to the Security and Initialization Network 765. The process starts at step 770 and immediately proceeds to step 772. Step 772 starts a loop in which wherein an iteration is performed for each processor that is to be initialized. For each processor that is to be initialized, the KDIC 735 prepares a message using the following process. In step 774 the KDIC 735 determines which Security Network Node 820 (see FIG. 8) corresponds to the processor 2400 for which the message is being prepared. In step 776 the public key corresponding to that Security Network Node 820 is retrieved from the Public Key Database 745. In step 778 this key is sent to the Key Packet Generator 740. The public key allows messages destined for the selected Security Network Node 820, which holds the corresponding private key (originally installed in the Security Network Node 820 during manufacture) to be encrypted in such a way that only the selected Security Network Node 820 can decrypt the message.

The Key distribution and network initialization server 730 also contains a Master Private Key 750, which it can use to digitally sign messages that it sends and a public key which allows verification of the digital signature produced by the Master Private Key 750. This public key is similar to the private key that is originally installed in the Security Network Nodes 820 during manufacture. With these keys it is possible for the Key distribution and network initialization server 730 to send data to a specific Security Network Node 820 that can only be read by that specific Security Network Node 820. These keys also allow the Security Network Node 830 to verify the data to have been sent by the trusted Key distribution network initialization server 730. The Key Packet generator 740 hardware is designed so that the Master Private Key does not have to be loaded into the memory of the Key distribution and network initialization server 730. The danger with loading such a key into memory is that it is possible that the key could be read by an attacker that has access to the memory. For example, one attack that has been used is to physically read the capacitors of memory using a special device. This works because memory may hold data in capacitors which, depending on the manufacture of the capacitors, can be detected hours or more after the computer has been turned off. If the Master Private Key is obtained by an attacker then it is possible for the attacker to initialize the security of the network, thereby compromising the subsequent network traffic to spying.

The Key Packet Generator 740 receives a public key from the Public Key Database 745 with which it will encrypt the outgoing message. In step 780 the Key Packet Generator then generates a key 755 that will be used for efficient encryption and decryption, such as a Symmetric key for AES-256. Suppose a key is generated such as ABC1. If ABC1 is a symmetric key, which works with a specific symmetric key encyprtion/decryption algorithm, then any node that knows the key can both read and send messages to other nodes that have the same key. Nodes that do not have the key cannot read the messages.

The Key table 760 holds keys that have been generated by the Key Generator 755, which allows the same Symmetric key to be sent in multiple messages. Using a hardware solution for the Key Packet Generator prevents the Symmetric key from ever being loaded within the memory of the Key distribution and network initialization server 740. It is therefore more difficult for an attacker to discover the Symmetric key in order to read messages.

Note that it is possible for the Public Key Database 745 to be implemented within the Key Packet Generator 755 so that it is more difficult for an attacker to insert their own public key into the public key database 745 in the hopes of being sent an encrypted message from the Key Packet Generator 740 that can be decrypted.

Two symmetric keys are generated for a given program, one that will not be loaded into user accessible memory and one that will be loaded. The key that will be loaded into memory is more vulnerable to attack. Therefore, a second key is used so that if the first key is discovered by an attacker it is still not possible for the attacker to read all of the messages. While custom hardware can be designed so that keys do not need to be loaded into memory, it may also be necessary to integrate computer hardware that is not custom and uses software to perform encryption and decryption, thereby requiring the key to be loaded into memory. Using the two-key system an attacker will have much more difficulty reading messages that are sent from custom hardware to other custom hardware, when the custom hardware uses keys that are not saved in user-accessible memory at any point in the system.

In step 782 the Symmetric keys are digitally signed using the Master Private Key 750 within the Key Packet Generator 740, and then in step 784 the signed keys are encrypted using the public key previously loaded from the public key database 745. In step 790 the list of recruited processors and servers (called a white list) and boot data, which has previously been received as input 725, is sent to Key Packet Generator 740 for signature, encryption, and inclusion in the packet. The signature key and encryption keys are the same as those used in steps 782 and 784. In step 786 the packet is sent to the proper Security Network Node over the Security and Initialization Network 765. The loop returns to step 772 until all processors have been initialized, At that point the ending step 788 is reached.

FIG. 8 shows the Security and Initialization Network 765, which transmits keys from the Key distribution and network initialization server 730 to the security network nodes 820 via security network switches 810. It is noteworthy that user programs running on processors 2400 cannot send or receive messages over this network. This makes it more difficult for an attacker to read or manipulate keys. For example, even if an attacker had the Master Private Key 750 and was running code on a user processor 2400, the attacker would not be able to send new keys to the processors 2400 because the user processors do not have the ability to write data to the security and initialization network 765.

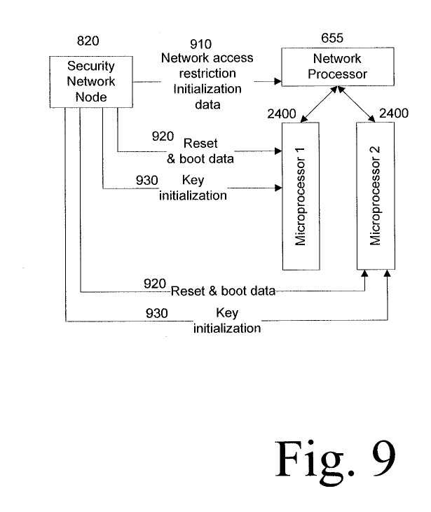

FIG. 9 shows the communication channels 910, 920, 930 by which the security network node 820 informs the network processors 655 and microprocessors 2400 of security and boot data. The security network node 820 sends a list of acceptable destinations and sources 910 for each microprocessor 2400. The list may be condensed, and the microprocessors 2400 may have been selected for their ability to be concisely described, such as by the beginning and ending of contiguous sources/destinations that are acceptable. Some network processors 655 do not directly attach to microprocessors 2400 and it is possible that all of the acceptable source/destination pairs (or contiguous groups) do not fit in the memory available for this purpose within the network processor 655. In this case, a blacklist may instead be transmitted, in which disallowed destination/source pairs are listed. When using a blacklist it is possible to not store all disallowed pairs. When there is insufficient memory this results in decreased security, but packet transmission is enabled. Reset and boot data is sent to the microprocessors 2400 via channel 920 from the security network node 820. The boot data may include a starting address and network server from which to retrieve an initial boot loader program. It can be seen that by changing the boot loader server/address for each program, or at least occasionally, it becomes less catastrophic to security if data within a single server or at a single address is replaced with malicious code. That is, in such a case one program may be compromised instead of all programs. Furthermore, it is possible to run a cleaning process on the server that provides the initial boot loader program. The cleaning process may be performed before every boot load. A previously cleaned server can be used by adjusting the boot server/address while recently used boot servers undergo the cleaning process anew. Key initialization data is sent via channel 930 to the microprocessors 2400. As noted previously, this key data is sent to a private memory not directly accessible to user code running on the microprocessors 2400.

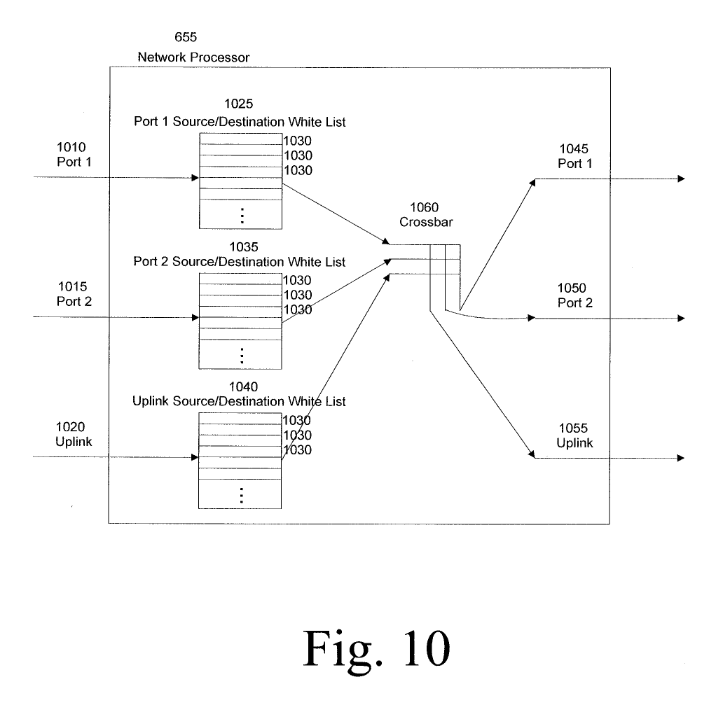

FIG. 10 shows a network processor 650 in accordance with a preferred embodiment of this invention. The network processor 650 routes packets arriving at ports 1, 2 and Uplink 1010, 1015, 1020 through the crossbar 1060, to one of the outgoing ports Port 1, 2 and Uplink 1045, 1050, 1055. The network processor 655 includes a white list table for each input port 1025, 1035, 1040. Each white list table has multiple entries 1030, each entry listing one or more sources and one or more destinations which are acceptable for all of the sources listed in the entry. When a packet arrives to a white list table, the entries that are applicable to the source of the packet are iterated through until an entry that includes the destination of the packet is found. If such a destination address is found the packet is forwarded via the crossbar 1060 to the appropriate outbound port. If, on the other hand, the destination address is not found amongst the searched entries then the packet is not sent. In one preferred embodiment the packet may initiate a process by which an administrator is notified as to the blocked packet (a packet that is not sent due to this process is called “blocked”).

As noted previously, it is possible for the white list to instead be used as a blacklist, in which case the packet is forwarded in the case that the applicable destination is not found. In this case the packet would instead be blocked if the destination address is found in the blacklist. In another embodiment two lists are used, one white and one black, and the packet is forwarded if the destination is found in the white list or if it is not found in the blacklist. This allows blacklisting of some source/destination pairs that must be allowed by using the white list to approve those pairs separately.

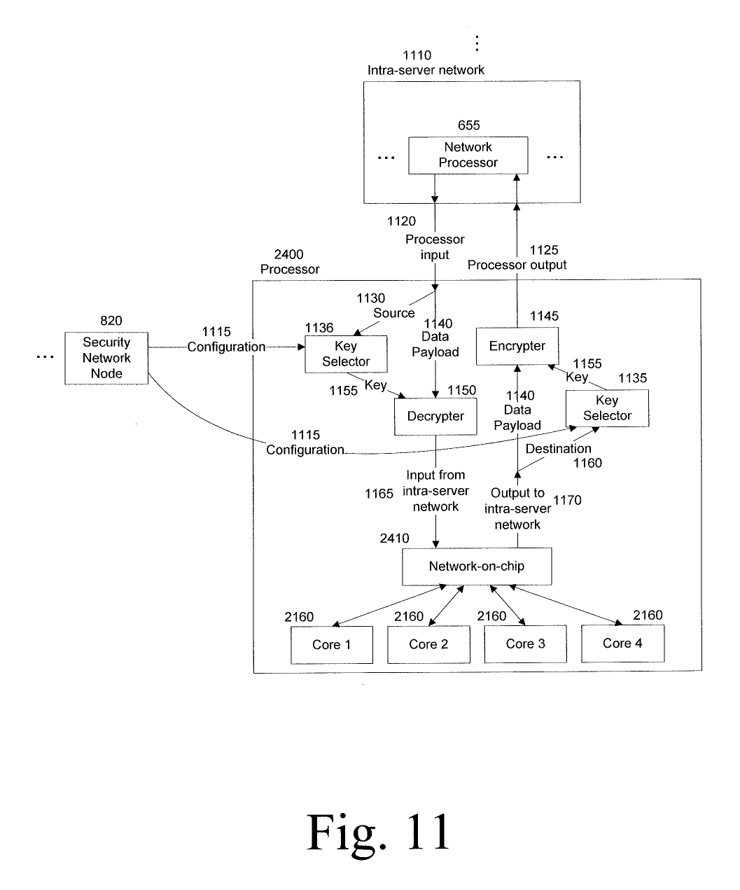

FIG. 11 shows the encryption and decryption mechanisms built into the processors 2400. The security network node 820 delivers the key configuration 1115 to the key selector for encryption 1135 and the key selector for decryption 1136. When a processor core 2160 sends a message bound for a destination that is off-chip, the network-on-chip 2410 sends the data payload 1140 via output 1170 to the Encrypter 1145, and the destination address 1160 for the data payload 1140 to the Key selector 1135. The Key selector 1135 identifies whether a first or second key is to be used based on the destination and sends the selected key 1155 to the Encrypter 1145. Once the Encrypter 1145 receives both the data payload 1140 and the selected key 1155, the message is encrypted using the selected key 1155 and sent through processor output 1125 for passing on the intra-server network 1110 via network processors 655. The Intra-server network 1110 may itself forward the packet to the Inter-server network (not shown) using an uplink. That is, the intra-server network is not meant to be a limiting term, but instead designates that the network is not on-chip in the illustrated embodiment.

Decryption works in a similar manner to the encryption process described above. In decryption, an incoming packet to the processor 1120 has its data 1140 sent to the Decrypter 1150 and its source address 1130 sent to the Key Selector 1136. The Key Selector 1136 uses the Source address 1130 to determine a key 1155 which is then sent to the Decrypter 1150. Once the Decrypter receives both the data payload 1410 and key 1155, the message is decrypted and sent to the network-on-chip 2410 via channel 1165.

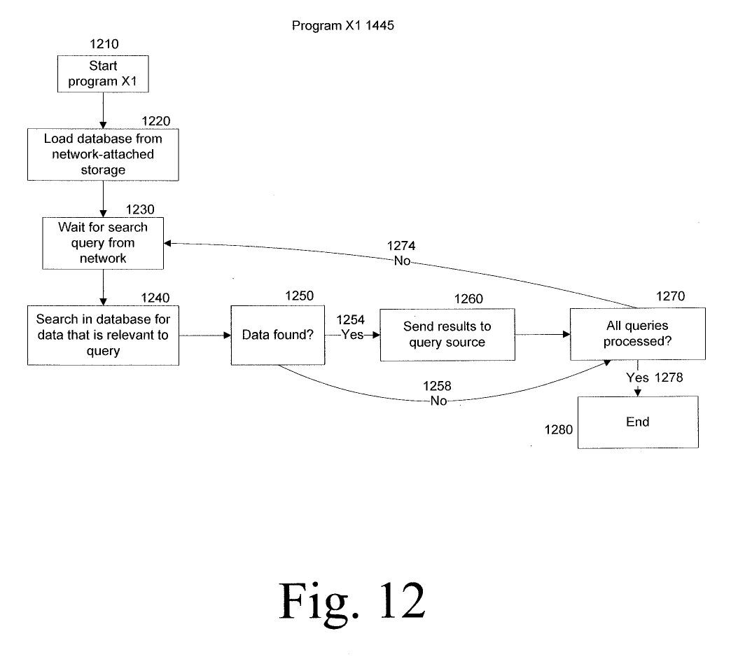

FIG. 12 shows a flow chart illustrating steps of an example application X1 that may be run simultaneously with another application. The program X1 searches a database and requires communication between a set of microprocessors, a network-attached-storage server, and a query server. Program X1 proceeds from start step 1210 to step 1220 in which a database is loaded from network-attached storage. Once the database is loaded, in step 1230 the program waits for a search query to arrive from the network. When a query arrives, in step 1240 the database is searched for data that is relevant to the query. In step 1250 if data is found the execution proceeds to step 1260 via path 1254. In step 1260 the results are sent back to the source of the query, after which the process proceeds to step 1270. In the case that no data was found, step 1260 is skipped and execution proceeds to step 1270 via path 1258. In step 1270 it is determined whether all of the queries have been processed, and if so, the program ends in step 1280 by following path 1278. If more queries must be processed then the program proceeds back to step 1230 via path 1274 and waits for the next query to be received.

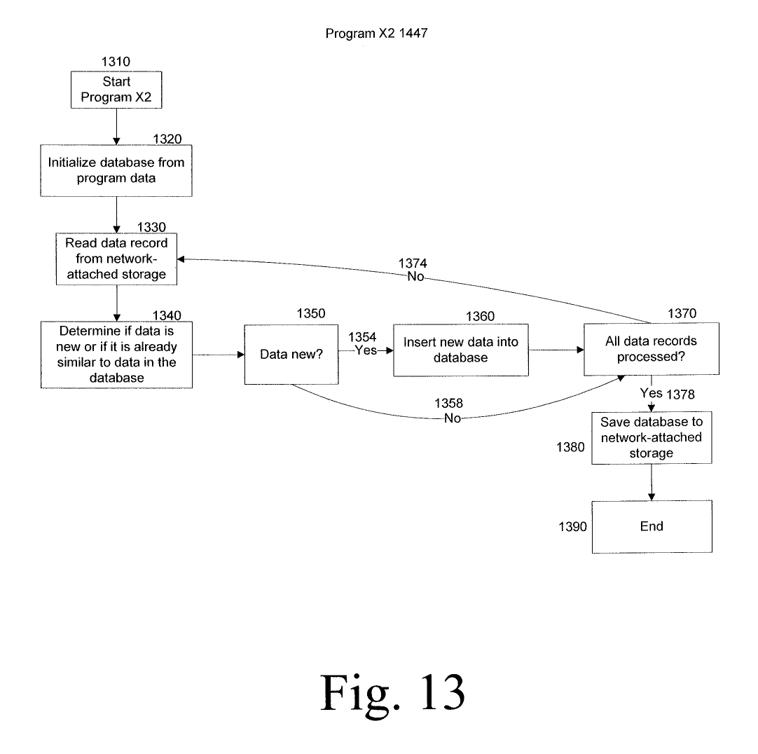

FIG. 13 is a flow chart illustrating steps of a second program X2 for inserting new data into a database that may be run simultaneously with another application. The program X2 retrieves data from a network-attached storage server, determines if the data is new, and if so it is inserted into the database. Program X2 is an example of a program that might be run simultaneously with another program such as program X1. Program X2 requires communication between a set of microprocessors 2400 and a network-attached storage server. Program X2 starts at step 1310 and proceeds to step 1320, where a database is initialized from data included within the program X2. Next, a data record is read from network-attached-storage in step 1330. Step 1330 is an example of an operation that might be conducted in a Map-Reduce program. Map-Reduce programs typically fetch inputs from network-attached-storage, perform some operation such as filtration or duplicate detection, and then save the results to the network. These operations are performed within the program X2.

Next, the database is searched at step 1340 to determine whether it already contains data similar to the data record read in step 1330. The results are analyzed in step 1350 and if the data is new the program proceeds to step 1360 via path 1354. In step 1360 the new data is inserted into the database and the program proceeds to step 1370. If the data is not new then the program skips step 1360 and proceeds to step 1370 via path 1358.

Step 1370 checks whether all data records have been processed, and if so the program proceeds to step 1380 via path 1378. In step 1380 the database is saved and the program ends at step 1390. If not all data records have been processed then step 1370 proceeds to step 1330 via path 1374 and the next data record begins being processed.

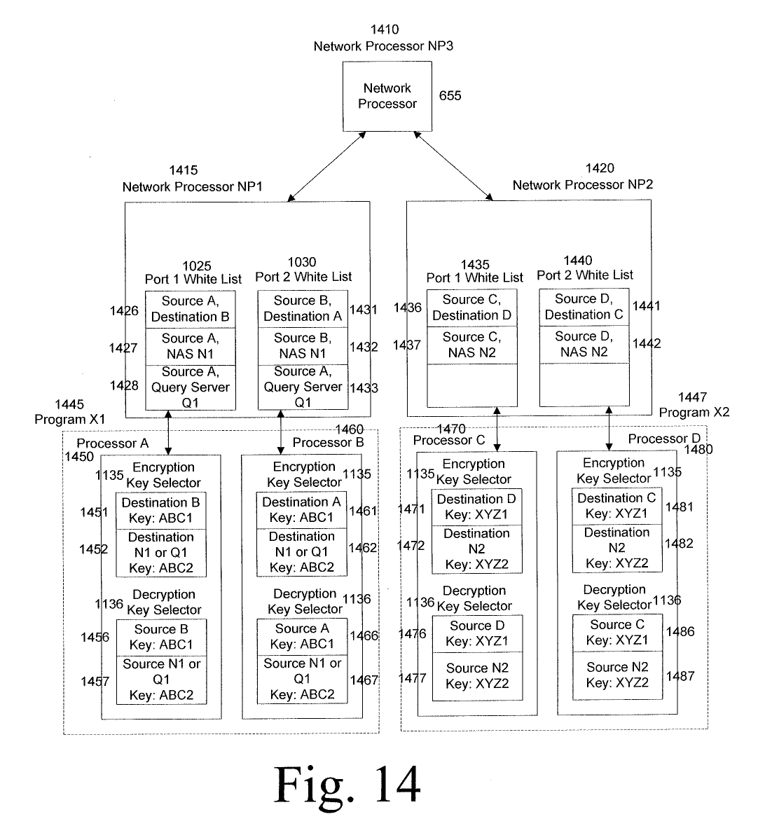

FIG. 14 shows a configuration of network processors NP1 1415 and NP2 1420 where programs X1 and X2 are simultaneously executing. The configuration of processors A 1450, B 1460, C 1470, and D 1480 are also shown. Processor A 1450 is running program X1 1445. The encryption key selector 1135 for Processor A 1450 includes two entries. The first entry 1451 designates use of key ABC1 for use when sending messages to Processor B 1460. A corresponding entry 1466 exists in processor B's 1460 Decryption Key Selector 1136, which designates key ABC1 for decryption. Because the key is a symmetric key the same key must be used for both encryption and decryption. Because the entries are the same, processor B 1460 will be able to decrypt messages sent to it from processor A.

It is possible that messages sent from processor A to processor B might not reach processor B due to unsuccessful forwarding at the network processor NP1 1415. To check if this is the case, the white list for Port 1 1025 is searched for all of the entries for which processor A is a source. Entries 1426, 1427 and 1428 qualify and may contain a valid destination to allow messages to pass to processor B. To fully verify that packets can be transferred from Processor A 1450 to processor B 1460 the first entry is checked and it can be seen that Destination B is indeed valid. (Note that if this was a blacklist the presence of such an entry would invalidate such message passing.) Thus, Program X1 1445 running on processor A 1450 and processor B 1460 can pass messages from Processor A 1450 to processor B 1460.

Because both processor A 1450 and processor B 1460 are running program X1 1445 it may be necessary for processor B 1460 to pass messages to processor A 1450. In order for these messages to be successfully sent and read by processor A there must be a relevant entry in the encryption key selector 1135 with a matching key in the decryption key selector 1136 of processor A 1450. Both tables have an entry ABC1, the first key for Destination A 1461 for encrypting messages from Processor B 1460 to processor A 1450. The second table entry designates use of the same key ABC1 for decrypting messages received by Processor A 1450 from processor B 1460.

The situation for processors C 1470 and D 1480 is the same, except that the key for the relevant key selectors 1135, specify the key XYZ1 for encryption and decryption. In this case the relevant entries are 1471, 1476, 1481, and 1486.

Processors A and B use key ABC2 for communication with servers N1 and Q1, as designated by key selector entries 1452, 1457, 1462, and 1467. Messages sent from processor A 1450 and processor B 1460 to servers N1 and Q1 are allowed within the network processor NP1 1415 because the corresponding entries 1427, 1428, 1432, and 1433 are present. It may be possible, similar to the key selector tables, to use one entry to designate both server N1 and Q1 as valid. This could be implemented, for example, by giving N1 and Q1 network addresses that are contiguous. Any number of servers can be allowed in this way, and keys can be validated in this way, provided the network addresses are contiguous.

Entries 1437 and 1442 similarly allow program X2 1447 running on processor C 1470 and D 1480 to send messages to server N2. The key that is used for encryption and decryption with server N2 is designated by entries in the key selectors 1135, 1136 of keys 1472, 1482, 1487 and 1487. This key is designated as key XYZ2. Note that servers N1, Q1, and N2 similarly have the keys ABC2, ABC2, and XYZ2 respectively, which are used for communicating with each other (in the case of N1 and Q1, which are used by program X1), and with also with the processors 2400 running their respective program.

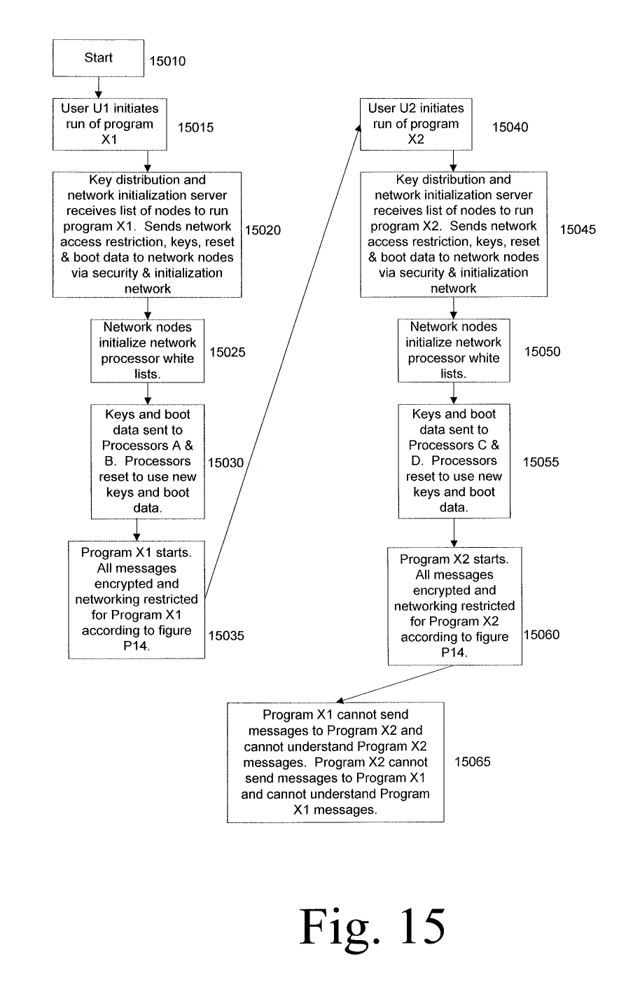

FIG. 15 shows a flow chart illustrating steps by which network security is provided to applications X1 and X2 when they run simultaneously. For purposes of this example, it is assumed that program X1 starts first and program X2 starts before program X1 completes. The process begins at step 15010 and proceeds immediately to step 15015 where user U1 initiates execution of program X1. At step 15020 the key distribution network initialization server 730 receives a list of server nodes 2400 and other servers that will run program X1. Network access restriction data, in the form of white list table entries for network processors 655 are generated, and keys and boot data are also generated for program X1. This data is sent via the security and initialization network 765 to the Security Network Nodes 820 which will communicate them to the processors 820. If servers will run or provide services to program X1 but are not connected to the security and initialization network 765, then a similar process is used with a special key (ABC2 in FIG. 14) and is transmitted over the regular datacenter network 610. In the case of program X1, both N1 and Q1 will receive key ABC2 via the datacenter network 610.

In steps 15025 and 15030 the security network node 820 configures the network processor 1415 and processors 1450, 1460 with the keys, boot data and white list table entries, which involves signaling a reset to initiate boot of the processor 2400 after configuration. In step 15035 program X1 starts, processors A and B use proper keys, and messages are properly disallowed from servers not running or servicing program X1 to destinations running or servicing program X1. Furthermore, messages are disallowed from program X1 to destinations not running or servicing program X1.

Steps 15040—15060 for program X2 proceed similar to steps 15015-15035 for program X1. After the programs have been initiated and the security has been set up, the process proceeds to step 15065. In step 15065 both program X1 and program X2 are simultaneously executing. Program X1 cannot send messages to program X2, nor can program X2 send messages to X1. Similarly, Program X1 cannot understand messages sent from Program X2 and Program X2 cannot understand messages sent from Program X1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of providing network security for executing a plurality of applications, the network including one or more servers, each server including (i) a plurality of microprocessors, and (ii) a plurality of network processors, the method comprising:
(a) defining a first grouping of microprocessors for executing a first application;
(b) executing the first application using the microprocessors in the first grouping of microprocessors, wherein the microprocessors in the first grouping of microprocessors are permitted to communicate with each other via one or more of the network processors;
(c) defining a second grouping of microprocessors for executing a second application, wherein at least one server has one or more microprocessors for executing the first application and one or more different microprocessors for executing the second application;
(d) executing the second application using the microprocessors in the second grouping of microprocessors, the second execution initiating execution prior to the completion of execution of the first application, wherein the microprocessors in the second grouping of microprocessors are permitted to communicate with each other via one or more of the network processors; and
(e) preventing, via one or more of the network processors, the microprocessors in the first grouping of microprocessors from communicating with the microprocessors in the second grouping of microprocessors during periods of simultaneous execution of the first and second application.

2. The method of claim 1 further comprising:
(f) configuring the network processors to define communication permissions of the groupings of the microprocessors via a second network, wherein the plurality of microprocessors are permanently prevented from accessing the second network.

3. The method of claim 1 wherein the plurality of microprocessors includes encryption/decryption functionality, the method further comprising:
(f) assigning a first encryption key to the first grouping of microprocessors, and assigning a second encryption key to the second grouping of microprocessors, wherein the first encryption key is different from the second encryption key, and wherein the first and second groupings of microprocessors do not know each other's encryption keys.
